(19) United States
(12) Patent Application Publication
(10) Pub. No.: US 2016/0139068 A1
(43) Pub. Date: May 19, 2016

(54) METHOD FOR MEASURING COEFFICIENT OF THERMAL EXPANSION AND THERMAL MECHANICAL ANALYZER

(71) Applicant: SAMSUNG ELECTRO-MECHANICS CO., LTD., Suwon-Si (KR)

(72) Inventors: Youn Gyu Han, Suwon-Si (KR); Jung Hwan Park, Suwon-Si (KR); Dong Keun Lee, Suwon-Si (KR); Keung Jin Sohn, Suwon-Si (KR); Dong Hoon Kim, Suwon-Si (KR); Cheol Ho Choi, Suwon-Si (KR)

(73) Assignee: SAMSUNG ELECTRO-MECHANICS CO., LTD., Suwon-Si (KR)

(21) Appl. No.: 14/542,366

(22) Filed: Nov. 14, 2014

(51) Int. Cl. G01N 25/16

(52) U.S. Cl. CPC G01N 25/16

(57) ABSTRACT

There is provided a method for measuring a coefficient of thermal expansion including: a step (S100) of providing two or more samples; a step (S200) of obtaining measured coefficients of thermal expansion of the two or more samples by means of a thermal mechanical analyzer; and a step (S300) of deriving a correction expression of an estimated coefficient of thermal expansion that is to be applied to the thermal mechanical analyzer through the two or more measured coefficients of thermal expansion obtained in the step (S200) and a linear regression analysis.

### CROSS-REFERENCE TO RELATED APPLICATION

This application claims the benefit of Korean Patent Application No. 10-2013-00058731, filed on May 24, 2013, entitled “Method for Measuring Coefficient of Thermal Expansion and Thermal Mechanical Analyzer” which is hereby incorporated by reference in its entirety into this application.

### BACKGROUND

The present disclosure relates to a method for accurately measuring a coefficient of thermal expansion through error correction of a thermal mechanical analyzer.

The present disclosure provides a method for more accurately measuring a coefficient of thermal expansion of a polymer film used in a semiconductor package, an electrical circuit, or the like, and a thermal mechanical analyzer using the same.

As well-known, coefficients of thermal expansion (hereinafter, referred to as CTEs) of various types of samples (for example a polymer material and a metal sample) are measured using a thermal mechanical analyzer (hereinafter, referred to as a TMA) or a dilatometer. The TMA or the dilatometer, which is a device measuring a size change or a volume change of the sample as a function of a time, a temperature, and a force, has been used to measure a glass transition temperature of a polymer, or the like, as well as the above-mentioned coefficient of thermal expansion.

In other words, the TMA includes a plurality of components embedded therein in order to calculate various measurement values. Generally, the TMA, which uses a principle that a length of the sample to which heat is applied is increased, detects a degree of the size change of the sample that depends on a temperature.

The TMA calculates a measurement value different from an actual coefficient of thermal expansion of the sample already known due to variables such as a difference between a heating expansion coefficient of the sample and an expansion coefficient of a plurality of components, for example, a probe, mounted in the TMA, a difference between a temperature of a heated sample and an internal temperature of a heating furnace, and the like. Therefore, a measurement coefficient CTE_{obs} of thermal expansion measured by the TMA provides a correction constant K associated with the TMA as represented by Mathematical Expression 1 so as to consider the above-mentioned complex variables in addition to an actual coefficient of thermal expansion of the sample known theoretically, that is, a theoretical coefficient CTE_{ref} of thermal expansion.

CTE_{obs}=GTE_{ref}sK [Mathematical Expression 1]

In Mathematical Expression 1, which is a scheme of correcting the coefficient of thermal expansion of the sample by only the correction constant K and the theoretical coefficient CTE_{ref} of thermal expansion, a considerable error is present between the coefficient of thermal expansion of the sample and an actual coefficient of thermal expansion of the sample.

In order to minimize this error, those skilled in the art have studied various methods. In Patent Document 1, thermal expansion values of materials of a sample tube of a TMA and a probe and a standard sample of which a coefficient of thermal expansion is already known are measured to calculate an estimated coefficient of thermal expansion of the sample tube based on expansion behavior of the standard sample and calculate a coefficient of thermal expansion of a sample using a relative thermal expansion value of the probe for the tube together with the estimated coefficient of thermal expansion of the sample tube as a correction factor.

A method disclosed in Patent Document 1 has a similar idea in that it is to remove an error due to an equipment, such that it is more accurate than a method that is generally used currently and is effective in measuring a sample on a thick block or a thick sheet such as a tube type sample, but is not appropriate for measuring a thin film sample.

In order to measure thermal expansion of the film sample, a dedicated probe, a dedicated stage, and a dedicated clamp as shown in FIG. 1 are required. Patent Document 2, which ignores or corrects an influence of a clamp used in a mode of measuring a film type sample, provides a method of manufacturing a clamp using a material of which thermal expansion is hardly present or manufacturing a clamp using a material of which a coefficient of thermal expansion is known and using a length change of the clamp according to a temperature as a correction coefficient. When this method is used, the film sample may be more accurately measured.

However, in Patent Document 2, an error that may occur due to a temperature gradient generated by a structural difference between the stage and the probe, thermal expansion according to the temperature gradient, thermal expansion of internal components of an equipment, vibrations according to driving of a motor, etc., and the like, is not considered, such that the measured sample is not reliable. In addition, even though a result value depends on the standard samples, the number of samples is very restrictive, such that it may not be recognized whether accurate correction has been made in the case in which a difference of a coefficient of thermal expansion from a measurement sample is large.

### RELATED ART DOCUMENT

### Patent Document

(Patent Document 1) Korean Patent No. 10-0119003

(Patent Document 2) US Patent Application Publication No. 2002/0136262

### SUMMARY

An aspect of the present disclosure may provide a method for measuring a coefficient of thermal expansion of a sample in consideration of entire behavior (particularly, contraction behavior) of a thermal mechanical analyzer (TMA) measuring the coefficient of thermal expansion of the sample.

According to an aspect of the present disclosure, a method for measuring a coefficient of thermal expansion may include: a step (S100) of providing two or more samples; a step (S200) of obtaining measured coefficients of thermal expansion of the two or more samples by means of a thermal mechanical analyzer; and a step (S300) of deriving a correction expression of an estimated coefficient of thermal expansion that is to be applied to the thermal mechanical analyzer through the two or more measured coefficients of thermal expansion obtained in the step (S200) and a linear regression analysis.

In the step (S100), the two or more samples may be made of different materials of which theoretical coefficients of thermal expansion are already known.

The step (S200) may be repeatedly performed by the number of different samples provided in the step (S100) to collect measured coefficients of thermal expansion of each sample.

In the step (S300), the correction expression of the estimated coefficient of thermal expansion may be configured of a linear equation using the measured coefficients of thermal expansion and a known coefficient of thermal expansion as an independent variable.

In the step (S300), the correction expression of the estimated coefficient of thermal expansion may be calculated by a method of least squares.

The step (S300) may include a step of confirming a value of a coefficient (R²) of determination. The coefficient of determination may allow approachability to the correction expression of the estimated coefficient of thermal expansion configured of the linear equation to be confirmed. Preferably, the coefficient of determination may be an index indicating that a state is optimal as it becomes close to 1.

According to another aspect of the present disclosure, a thermal mechanical analyzer controlled by the method for measuring a coefficient of thermal expansion as described above may be provided.

The thermal mechanical analyzer may include: a heating part heating and cooling a sample; a driving part providing tensile force to the sample; a displacement measuring part; a probe extended from the driving part through the displacement measuring part; a stage; a movable clamp connected to the probe; and a fixed clamp fixed to one side of the stage.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view schematically showing a thermal mechanical analyzer (TMA); and

FIG. 2 is a flow chart showing a method for measuring a coefficient of thermal expansion of a sample in the same TMA according to an exemplary embodiment of the present disclosure.

### DETAILED DESCRIPTION

The objects, features and advantages of the present disclosure will be more clearly understood from the following detailed description of the exemplary embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present disclosure, when it is determined that the detailed description of the related art would obscure the gist of the present disclosure, the description thereof will be omitted.

Hereinafter, exemplary embodiments of the present disclosure will be described in detail with reference to the accompanying drawings.

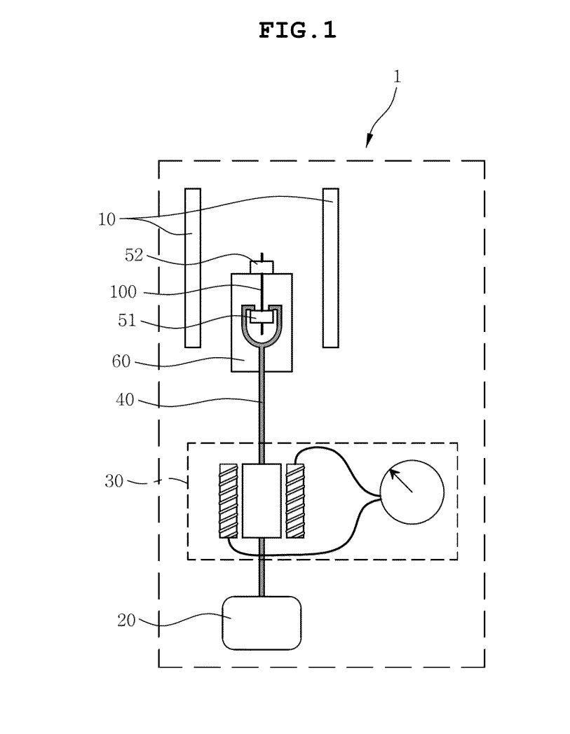

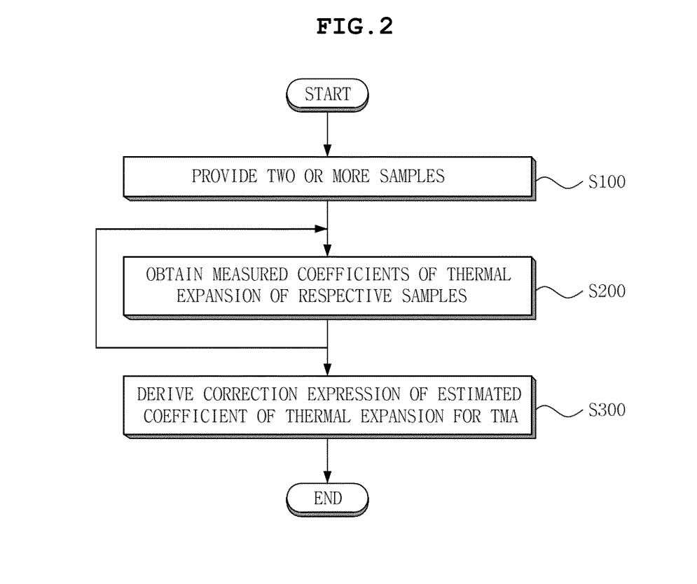

FIG. 1 is a diagram illustrating a camera module of an auto focus function to which an apparatus for driving a voice coil motor actuator according to a first exemplary embodiment of the present disclosure is applied and FIG. 2 is a diagram illustrating the apparatus for driving a voice coil motor actuator according to the first exemplary embodiment of the present disclosure.

Hereinafter, a method for measuring a coefficient of thermal expansion and a thermal mechanical analyzer according to an exemplary embodiment of the present disclosure will be described in detail with reference to the accompanying drawings.

FIG. 1 is a view schematically showing a thermal mechanical analyzer (TMA).

The thermal mechanical analyzer 1 (hereinafter, referred to as a TMA) is configured to include a heating part 10, a driving part 20, a displacement measuring part 30, and a probe 40.

A sample 100 is supported by two clamps 51 and 52 in a stage 60 or a chamber (not shown). A movable clamp 51 is connected to the probe 40, while a fixed clamp 52 is fixed to one side of the stage 60.

The sample 100 has tensile force or a load applied thereto through the driving part 20, and an initial length of the sample 100 disposed between the movable clamp 51 and the fixed clamp 52 is first recorded. Then, in order to measure a coefficient of thermal expansion, the TMA 1 heats and/or cools the sample 100 through the heating part 10 disposed around the stage 60. Here, a length change of the sample 100 occurs according to the heating (or cooling), and the probe 40 connected to the movable clamp 51 may be displaced depending on the length change of the sample 100. Here, the sample 100 may have a thin film form in order to provide the length change according to a temperature change.

In detail, the probe 40 is extended from the movable clamp 51 to the driving part 20 through the displacement measuring part 30. The displacement measuring part 30 measures behavior of the probe 40 that depends on the length change of the sample 100.

Here, as the displacement measuring part 30, a linear variable differential transformer (LVDT) well-known to those skilled in the art may be used. When the probe 40 behaves, a behavior displacement is measured within the displacement measuring part 30.

The heating part 10 capable of precisely controlling heat applied to the sample 100 needs to be used, and a thermocouple may be additionally provided in order to accurately measure a changed temperature of the sample.

FIG. 2 is a flow chart showing a method for measuring a coefficient of thermal expansion corresponding to a TMA equipment according to an exemplary embodiment of the present disclosure. Particularly, in an exemplary embodiment of the present disclosure, a correction expression of a coefficient of thermal expansion of the TMA equipment measuring samples formed of different materials of which coefficients of thermal expansion are already known is calculated, thereby making it possible to measure a reliable coefficient of thermal expansion. In the method for measuring a coefficient of thermal expansion according to an exemplary embodiment of the present disclosure, an error occurring in the used TMA equipment may be minimized, and measurement of a low coefficient of thermal expansion is enabled.

First, the method for measuring a coefficient of thermal expansion according to an exemplary embodiment of the present disclosure includes a step (S100) of providing two or more samples.

In step (S100), the two or more samples are provided as described above. Here, the respective samples are made of materials of which coefficients of thermal expansion are already known. Although lengths and thicknesses of the samples are not limited, they need not to be larger than a size of a heating furnace. In the case of Q400 of a TA company, samples having a length of about 8 mm, 16 mm, or 24 mm and a thickness of 400 μm or less may be used.

Preferable, the samples are films (or foils) having a length of 16 mm or more and a thickness of 200 μm so as to sensitively react to a temperature change.

Then, the method for measuring a coefficient of thermal expansion according to an exemplary embodiment of the present disclosure includes a step (S200) of obtaining measured coefficients CTE_{obs} of thermal expansion of the respective samples through the TMA. The measured coefficients CTE_{obs} of thermal expansion may be calculated by an analysis program based on data on a displacement amount, a temperature difference, a time, and the like, of the probe obtained through the TMA equipment.

In an exemplary embodiment of the present disclosure, two or more samples are provided as described in step (S100). The respective samples need to be made of materials different from each other and having known theoretical coefficients of thermal expansion.

In step (S200), in order to obtain the measured coefficients CTE_{obs} of thermal expansion of the respective samples, an experiment is repeatedly performed by the number of measurement samples to measure the measured coefficients CTE_{obs} of thermal expansion of the respective samples.

Particularly, in step (S200), for example, in the case in which two samples are adopted, the two samples different from each other, that is, first and second samples need to be measured within the same TMA. In other words, a coefficient of thermal expansion of the second sample is again measured within the TMA measuring a coefficient of thermal expansion of the first sample. This is to correct the coefficients of thermal expansion of the samples based on the TMA to be used.

In order to improve reliability for measurement of the coefficient of thermal expansion by the TMA equipment, the present disclosure is not limited to providing the two samples described above, but may provide three or more samples different from each other. A third sample, a fourth sample, . . . , an N-th sample need to be made of materials different from each other and different from those of the first and second samples. Therefore, in an exemplary embodiment of the present disclosure, a step of providing samples and a step of obtaining measured coefficients of thermal expansion need to be repeatedly performed N times in accordance with the number of kinds of different samples.

After the measured coefficients of thermal expansion for the respective different samples are collected, the method for measuring a coefficient of thermal expansion according to an exemplary embodiment of the present disclosure includes a step (S300) of calculating an estimated (actual) coefficient CTE_{cal} of thermal expansion of the TMA through a linear regression analysis. In detail, in step (S300) of the method for measuring a coefficient of thermal expansion according to an exemplary embodiment of the present disclosure, a correction expression of a linear equation may be calculated by a finite element analysis of a correlation between data of the measured coefficients CTE_{obs} of thermal expansion of the respective samples measured in the TMA measuring theoretical coefficients CTE_{ref} of thermal expansion of the respective samples.

Preferentially, in step (S300) of the method for measuring a coefficient of thermal expansion according to an exemplary embodiment of the present disclosure, the measured coefficients CTE_{obs} of thermal expansion of the respective samples, which are independent variables, are replaced to obtain data pair of theoretical coefficients CTE_{ref} of thermal expansion of the respective samples, which are dependent variables. In other words, the measured coefficients CTE_{obs} of thermal expansion and the theoretical coefficients CTE_{ref} of thermal expansion corresponding to the respective samples have a predetermined rule, and a correlation between these two variables is defined as a function of y=f(x). This function approaches a linear equation (y=ax+b, where y is a dependent variable, x is an independent variable, a is a regression coefficient, b is an error term). In step (S300), a method of least squares capable of calculating a function value (f(x)) allowing a sum of a square of a difference between a correction value (y) and the function value (f(x)) to be minimum is used. The regression coefficient (a) and the error term (b) of the linear equation may be calculated from two or more data pairs that may be derived from two or more samples. The correction expression of the linear equation calculated as described above may be used as a correction expression for the coefficient of thermal expansion of the TMA actually measuring the measured coefficient of thermal expansion. Since the above-mentioned correction expression is a relational expression corresponding to the TMA equipment used for each measurement, the TMA equipment used for the measurement does not need to calculate a separate correction expression later and confirms a coefficient of thermal expansion with respect to a sample of which an accurate component may not be confirmed, thereby making it possible to confirm the accurate component of the sample.

Optionally, the method for measuring a coefficient of thermal expansion according to an exemplary embodiment of the present disclosure further includes a step of confirming a variance degree of the estimated coefficients CTE_{cal} of thermal expansion through a linear correction expression of two variable values. In the case in which the variance degree of the variable values is large, a prediction degree of a linear regression equation is significantly decreased, and an index, that is, R² (coefficient of determination), capable of describing this change degree may be confirmed. Since the linear equation and the coefficient of determination according to the method of least squares may be easily derived from the variable values (or data pair), a detailed description thereof will be omitted in order to clearly understand the present disclosure.

Therefore, in an exemplary embodiment of the present disclosure, when two or more different samples are measured in the same TMA to obtain a plurality of variable values, a linear regression equation, which is a more reliable correction expression, may be obtained.

The coefficient (R²) of determination has a value between 0 and 1. When the R-squired becomes closer to 1, it means that all of the variable values approach a straight line to maintain a linear relationship therebetween. Unlike this, when the R-squired becomes closer to 0, it may be appreciated that coordinates of the variable values do not have a linear relationship therebetween, but are dispersed.

The linear regression equation derived as described above depends on behavior of the TMA used to measure the samples, thereby making it possible to obtain the estimated coefficients CTE_{cal} of thermal expansion of different samples.

### Example 1

Example 1 is to calculate a correction expression, that is, a linear regression equation, corresponding to the TMA equipment through the method for measuring a coefficient of thermal expansion according to an exemplary embodiment of the present disclosure.

In Example 1, a Q400 product available from the TA Instruments was used as the TMA, and measurement was performed at a load of 0.1N and under a condition of N₂ flow 100 ml/min.

Coefficients of thermal expansion of tungsten (W), copper (Cu), and aluminum (Al) in a foil state of 24 mm×2 mm, which are measurement samples, were measured.

The following Table 1 shows the respective theoretical coefficients CTE_{ref} of thermal expansion of tungsten (W), copper (Cu), and aluminum (Al) that are to be used as the measurement samples.

TABLE 1

| | Theoretical Coefficients |
|---|---|
| | CTE_{ref} (ppm/° C.) of |
| Division | Thermal Expansion |
| Tungsten | 4.6 |
| Copper | 16.8 |
| Aluminum | 23.6 |

The respective samples were mounted in the above-mentioned TMA and were heated to 10° C./min. Measured coefficients CTE_{obs} of thermal expansion of the respective samples may be calculated based on the temperature difference and an amount of the length change measured by the displacement measuring part through the probe, as described above with reference to in FIG. 1. The measured coefficients of thermal expansion are shown in the following Table 2.

TABLE 2

| | Theoretical Coefficients | Measured Coefficients | |
|---|---|---|---|
| | CTE_{ref} (ppm/° C.) of | CTE_{obs} (ppm/° C.) of | Error |
| Division | Thermal Expansion | Thermal Expansion | (%) |
| Tungsten | 4.6 | 2.2 | −52.2% |
| Copper | 16.8 | 15.4 | −8.3% |
| Aluminum | 23.6 | 22.8 | −3.4% |

In an exemplary embodiment of the present disclosure, the linear equation (y=ax+b) is derived by the method of least squares based on the variable values (the measured coefficients of thermal expansion and the theoretical coefficients of thermal expansion) shown in Table 2 and is represented by the following Mathematical Expression 2. Here, the following Mathematical Expression 2 may be applied only under the TMA equipment and the condition of Example 1.

CTE_{cal}=0.9226sCTE_{obs}+2.5763 [Mathematical Expression 2]

When the measured coefficient CTE_{obs} of thermal expansion of the copper is substituted into Mathematical Expression 2 to actually calculate the estimated coefficient CTE_{cal} of thermal expansion of the copper, it may be confirmed that the estimated coefficient CTE_{cal} of thermal expansion of the copper is 0.9226×2.2+2.5763=4.60602.

Therefore, the estimated coefficient of thermal expansion of the copper and the theoretical coefficient of thermal expansion of the copper may coincide with each other, such that accurate coefficients of thermal expansion of the respective samples according to the TMA that is to be used for measurement may be measured. As described above, the measurement of the accurate coefficients of thermal expansion may minimize a warpage phenomenon that may occur due to, for example, coefficients of thermal expansion between compositions of a circuit board.

### Example 2

In Example 2, which is an example of applying the linear regression equation of Mathematical Expression 2 calculated in Example 1 to another sample, a measured coefficient CTE_{obs} of thermal expansion of platinum (Pt) measured under the same condition as that of Example 1 within the Q400 product available from TA Instruments used in Example 1 is substituted into Mathematical Expression 2 (for reference, a theoretical coefficient CTE_{ref} of thermal expansion of the platinum is 8.8 ppm/° C., and a measured coefficient CTE_{obs} of thermal expansion of the platinum used in Example 1 is 6.6 ppm/° C.).

A estimated coefficient CTE_{cal} of thermal expansion of the platinum is calculated as 0.9226×6.6+2.5763 8.7 ppm/° C.

With the method for measuring a coefficient of thermal expansion according to an exemplary embodiment of the present disclosure, it may be confirmed that when the measured coefficient of thermal expansion of the platinum is substituted into a correction expression, it coincides with (or approximates) the theoretical coefficient of thermal expansion of the platinum.

As set forth above, according to exemplary embodiments of the present disclosure, the present disclosure may provide the method for measuring a coefficient of thermal expansion capable of minimizing an error that may occur in the same TMA equipment that is to be used to measure the coefficient of thermal expansion. In other words, correction is required in each TMA equipment in order to obtain accurate coefficients of thermal expansion before each TMA equipment measures the samples. The present disclosure assists in calculation of correction expressions for each equipment.

In the method for measuring a coefficient of thermal expansion according to an exemplary embodiment of the present disclosure, an actual estimated coefficient of thermal expansion may be obtained from a measured coefficient of thermal expansion of an unknown sample in the TMA equipment that already provides the correction expression.

In addition, the present disclosure enables measurement of a low coefficient of thermal expansion.

The present disclosure measures a precise and reliable coefficient of thermal expansion of the sample, thereby making it possible to control quality of the sample and assist in the understanding for behavior of the sample.

Additionally, the present disclosure provides a method for measuring an accurate coefficient of thermal expansion of a thin organic or inorganic compound material film used in a semiconductor package, a printed circuit board, or the like, and assists in controlling a warpage phenomenon due to a difference between coefficients of thermal expansion of the respective compositions.

Although the embodiments of the present disclosure have been disclosed for illustrative purposes, it will be appreciated that the present disclosure is not limited thereto, and those skilled in the art will appreciate that various modifications, additions and substitutions are possible, without departing from the scope and spirit of the disclosure.

Accordingly, any and all modifications, variations or equivalent arrangements should be considered to be within the scope of the disclosure, and the detailed scope of the disclosure will be disclosed by the accompanying claims.

What is claimed is:

1. A method for measuring a coefficient of thermal expansion, comprising:
a step (S100) of providing two or more samples;
a step (S200) of obtaining measured coefficients of thermal expansion of the two or more samples by means of a thermal mechanical analyzer; and
a step (S300) of deriving a correction expression of an estimated coefficient of thermal expansion that is to be applied to the thermal mechanical analyzer through the two or more measured coefficients of thermal expansion obtained in the step (S200) and a linear regression analysis.

2. The method for measuring a coefficient of thermal expansion of claim 1, wherein in the step (S100), the two or more samples are made of different materials.

3. The method for measuring a coefficient of thermal expansion of claim 1, wherein the samples are made of materials of which theoretical coefficients of thermal expansion are known.

4. The method for measuring a coefficient of thermal expansion of claim 1, wherein the step (S200) is repeatedly performed by the number of different samples provided in the step (S100) to obtain measured coefficients of thermal expansion of each sample.

5. The method for measuring a coefficient of thermal expansion of claim 1, wherein in the step (S300), the correction expression of the estimated coefficient of thermal expansion is configured of a linear equation using the measured coefficients of thermal expansion as an independent variable.

6. The method for measuring a coefficient of thermal expansion of claim 1, wherein in the step (S300), the correction expression of the estimated coefficient of thermal expansion is calculated by a method of least squares.

7. The method for measuring a coefficient of thermal expansion of claim 6, wherein the step (S300) includes a step of confirming a value of a coefficient (R²) of determination.

8. The method for measuring a coefficient of thermal expansion of claim 1, wherein the thermal mechanical analyzer includes:
a heating part heating and cooling a sample;
a driving part providing tensile force to the sample;
a displacement measuring part;
a probe extended from the driving part through the displacement measuring part;
a stage;
a movable clamp connected to the probe; and
a fixed clamp fixed to one side of the stage.
